(19) United States
(12) Patent Application Publication
(10) Pub. No.: US 2024/0166571 A1
(43) Pub. Date: May 23, 2024

(54) METHOD FOR TREATING HUMAN OR ANIMAL URINE BY DILUTION AND FERMENTATION AND USES OF THE URINE OBTAINED IN PARTICULAR AS FERTILIZING SUBSTRATE

(71) Applicant: TOOPI ORGANICS, LOUPIAC DE LA REOLE (FR)

(72) Inventors: Pierre HUGUIER, LE PUY (FR); Michael ROES, DIEULIVOL (FR)

(21) Appl. No.: 18/281,887

(22) PCT Filed: Mar. 16, 2022
(86) PCT No.: PCT/EP2022/056884

§ 371 Date: Sep. 13, 2023

(30) Foreign Application Priority Data
Mar. 16, 2021 (FR) FR2102613

(51) Int. Cl. C05F 3/00; C05F 17/20; C05F 17/40

(52) U.S. Cl. CPC C05F 3/00; C05F 17/20; C05F 17/40

(57) ABSTRACT

The invention relates to a method for treating human or animal urine comprising the implementation of the following steps:
a step of diluting the urine in water, and
a step of fermentation.

The invention also relates to the transformed urine obtained and the coproducts of this method, and also the uses thereof, in particular as fertilizing substance.

### TECHNICAL FIELD

The invention relates to the treatment and recovery of human or animal urine. In particular, the invention relates to a method for treating urine and the use of the transformed urine obtained, as well as coproducts of the method, in particular as raw materials used for the manufacture of fertilizers.

### PRIOR ART

Urine is considered a waste that it is necessary to dispose of. Its current disposal mode, mainly via the general sewer, is problematic for purification plants and more generally relates to sustainable management of the water resource. The nitrogen and micro-pollutant content of urine in fact poses problems of the development of algae and of feminization of fish.

The prior art describes several methods for treating black water comprising a mixture of urine and excrement to obtain fertilizing substances or fertilizer. In particular, document FR2371399 is found, describing a method for treating waste of animal origin, in particular for uses thereof in animal feed or in soil.

The document KR20040062918 describes a manure composting method.

The document U.S. Pat. No. 6,379,546 describes a method for treating wastewater for recycling purposes.

The document CN111377759 describes a method for preparing liquid fertilizer from animal excrement.

The methods described in the prior art are not suitable for the treatment of urine alone. From the methods described in the prior art, it is not possible to obtain a stable fertilizing substance, rich in microorganisms, rich in NPK and meeting the safety criteria of the regulations in force.

Human urine is known to have a proven fertilizing potential in agriculture, in the same way as animal urine which is already used by farmers. Indeed, urine is rich in nitrogen (N), phosphorus (P) and potassium (K), which are the essential elements for fertilizing soil and crops.

However, urine is not stable when it is collected. It rapidly loses its characteristics and its NPK content, in particular via the hydrolysis of urea in ammonia, which makes its industrial use unsuitable and currently impossible.

There is therefore a need for stable urine, meeting the safety criteria of the regulations in force, in particular on the content of metallic trace elements and of pathogenic organisms, and which has characteristics enabling it to be used as a fertilizing substance suitable for agricultural use.

### SUMMARY OF THE INVENTION

By working on the treatment of urine, the inventors have developed a biological method which makes it possible to stabilize, decontaminate, and enrich in microorganisms human or animal urine by fermentation. However, urine can be too charged with nutrient elements for certain microorganisms. In particular, urine can be too charged with salt (NaCl) which may have a negative osmotic impact on microorganisms, in particular on bacteria and nitrogen which may be in toxic concentrations.

Thus, the inventors propose a urine treatment method comprising at least one dilution step so as to have optimum concentrations of mineral elements for microbial fermentation.

In particular, the invention relates to a method for treating human or animal urine comprising at least one step of fermentation of urine by microorganisms, preferentially bacteria, preceded by at least one step of diluting the urine in a solution, preferentially in water, preferentially at a factor of between 1/2 and 1/100.

According to a particularly suitable embodiment, the method according to the invention is a method for treating human or animal urine, preferentially fresh urine, comprising at least the following steps:
a step of acidification or basification of the urine,
a step of filtration of the urine,
a step of diluting the urine in a solution, preferentially in water or in a nutrient solution,
preferentially a step of stabilizing the pH at a desired value (acid, basic or neutral),
a step of transforming urine by fermentation.

The implementation of the dilution of urine, preferentially followed or preceded by a step of stabilizing the pH, makes it possible to carry out the fermentation with any type of microorganisms, since the undiluted acidified or basified urine comprises nutrient elements, such as salt and nitrogen, in concentrations that are toxic to certain microorganisms, as well as a pH that limits the growth of certain microorganisms.

The method may comprise other steps and in particular an optional step prior to the other steps, which consists of recovering from the urine at least one mineral in the form of a precipitate, in particular at least one mineral chosen from nitrogen, potassium or phosphorus.

The invention also relates to the transformed urine, capable of being obtained by the implementation of the method, and which has at least one of the following characteristics: a salt concentration (NaCl) of less than 0.15% by weight/volume (1.5 g/L) and a total nitrogen concentration of less than 0.5% by weight/volume (5 g/L) (the percentages are given by weight of salt or nitrogen relative to the volume of urine transformed). Without dilution, the urine could contain salt and nitrogen concentrations too great for its use, in particular for the fermentation of certain microorganisms.

The invention also relates to the use of such a urine transformed, in particular as fertilizing substance, in particular as fertilizing raw material based on inoculum of micro-organisms, preferentially based on bacterial inoculum, in particular for field crops, vegetable gardening, and horticulture. The invention therefore relates to a fertilizer.

The invention also aims to use the coproducts optionally obtained during the step of urine fermentation (in particular the biofilm formed during this step), in particular as fertilizing substance, as a plant protection product or as a biocontrol product for agricultural use.

### BRIEF DESCRIPTION OF THE FIGURES

FIG. 1a shows, in the form of a curve, the results obtained for diluting a fresh urine (collected less than 2 hours earlier) with demineralized water.

FIG. 1b shows, in the form of a curve, the results obtained for diluting a stored urine (stored for 5 days) with demineralized water.

FIG. 2a shows, in the form of a curve, the results obtained for diluting an acidified fresh urine (collected less than 2 hours earlier, acidified to pH 3) with demineralized water.

FIG. 2a shows, in the form of a curve, the results obtained for diluting a basified fresh urine (collected less than 2 hours earlier, acidified to pH 11) with demineralized water.

FIG. 3 shows, in histogram form, the concentrations of E. meliloti (UFC/mL) observed after 72, 96, 120, 144 and 168 hours of growth on pure urine, urine diluted to 1/2 and to 1/5. The *s represent the significant differences between the different dilution levels.

FIG. 4a represents, in histogram form, the comparative measurements of the number of soybean pods obtained near inoculation with commercial products (FORCE 48 and RHIZOFLO containing an adhesive like the invention) and with a product according to the invention (RHIZOPI+adhesive).

FIG. 4b represents, in histogram form, the comparative measurements of the ratio of seeds over the number of soybean pods obtained after inoculation with commercial products (FORCE 48 and RHIZOFLO containing an adhesive like the invention) and with a product according to the invention (RHIZOPI+adhesive).

FIG. 5 represents, in histogram form, the comparative measurements of the yield after inoculation with commercial products (FORCE 48 and RHIZOFLO containing an adhesive like the invention) and with a product according to the invention (RHIZOPI+adhesive).

### DETAILED DESCRIPTION OF THE INVENTION

### Definitions

“Urine” within the meaning of the invention refers to urine free of fecal material, and very preferentially collected separately.

“Acidified urine” within the meaning of the invention refers to a urine whose pH value has been reduced relative to the pH value of the initial urine. The pH of the acidified urine is an acidic pH.

“Basified urine” within the meaning of the invention refers to a urine whose pH value has been raised relative to the pH value of the initial urine. The pH of the basified urine is a basic pH.

“Diluted urine” within the meaning of the invention refers to a urine whether fresh or stored, acidified or not, basified or not, which has been diluted in a solution, preferentially in water or in a nutrient solution, to a certain factor.

“Fresh urine” within the meaning of the invention refers to a urine which was collected less than 10 hours earlier, preferentially less than 5 hours earlier, even more preferentially less than 2 hours earlier, and in particular less than 1 hour earlier.

“Transformed urine” within the meaning of the invention refers to a urine that has undergone a process that transformed at least one characteristic of the natural urine, so that it is no longer a natural product but a transformed product obtained from a natural product. Preferentially, the transformed urine is a urine transformed according to the invention at least by dilution and fermentation.

### Urine Treatment Method

The invention therefore relates to a method for treating human or animal urine, comprising at least one step of urine fermentation preceded by at least one step of diluting urine in a solution, preferentially in water or in a nutrient solution.

Thus, the invention relates to a method of human or animal urine comprising at least the following steps:
diluting the urine in the water or nutrient solution, preferentially to a factor of between 1/2 and 1/100 and
transforming urine by fermentation.

According to a particular embodiment, the invention relates to a method for treating human or animal urine, preferentially fresh urine, comprising at least the implementation of the following steps:
a step of urine basification or acidification, allowing storage up to 6 months,
a step of diluting the urine in the water or nutrient solution,
a step of filtration of the urine,
a step of transforming urine by fermentation.

The dilution step can be carried out before or after filtration.

According to one variant, the dilution can be carried out several times, and the method according to the invention may comprise several dilution steps, in succession or interspersed with other steps.

Human or animal urine is collected by any method suitable for implementing the method according to the invention.

For human urine, it can in particular be collected from different sources such as toilet rental companies, festivals, medical analysis laboratories, and communities.

For animal urine, it can in particular be collected from different sources such as farms and veterinary analysis laboratories.

The human or animal urine is collected in containers such as cans, casks or tanks, for example. According to one embodiment, the containers may contain one or more bases for implementing the basification step or one or more acids for implementing the acidification step.

Optionally, the method according to the invention may optionally comprise an additional step, which consists of precipitating co-products generated during the storage step before dilution and/or basification and/or acidification. These co-products are preferentially minerals, in particular minerals chosen from nitrogen, potassium and phosphorus (struvite). In the particular case of the recovery of the struvite present in urine, the method consists of adding magnesium salts in solution in order to precipitate the phosphorus present in urine stored without stabilizer, preferentially at a volumetric ratio of 1:1 (Mg:P). This precipitate can be recovered by filtration on a lattice filter of between 10 and 30 μm. The precipitate can subsequently undergo various treatments, such as washing, dissolving, pressing and/or open-air drying in order to obtain a material in liquid or solid form.

The first step of the method according to the invention is preferentially carried out on fresh urine which was collected less than 10 hours before the implementation of the first step of the method according to the invention, preferentially less than 5 hours, even more preferentially less than two hours and ideally less than one hour.

The urine dilution step is carried out with water or in a nutrient solution.

The water used for the dilution is preferentially demineralized water.

The nutrient solution is preferentially water, preferentially demineralized water, to which was added a carbon source (sugar) and/or any other growth factor suitable for any microorganisms, preferentially suitable for bacteria (such as yeast extracts and/or dried blood and/or mineral elements, etc.), in particular bacterial growth factors absent from urine, in such a way that the dilution solution can provide nutritional elements complementary to those of urine.

Preferentially, the dilution step is carried out before the fermentation step such that the urine has a composition of nutrients, in particular salt and nitrogen, suitable for any microorganism, preferentially a salt concentration (NaCl) of less than 0.15% by weight and a nitrogen concentration of less than 0.5% by weight. According to a particularly suitable embodiment, the dilution is carried out in the water or nutrient solution at a factor of between 1/2 and 1/100.

The urine basification step, when implemented, is preferentially carried out such that the urine has a pH greater than or equal to 9, preferentially between 9 and 12, preferentially greater than or equal to 10 and according to an embodiment comprised between 10 and 12. The basification of urine to a pH greater than 9 makes it possible to inhibit the growth of the pathogens and prevents the spontaneous reaction of hydrolysis of the urea with ammonia, and therefore the urine retains its nitrogen concentration. Basification in particular can also allow urine to have the pH necessary for urine fermentation by certain microorganisms, in particular certain bacteria.

The basification step can be carried out by any means making it possible to obtain a urine with the desired basic pH. In particular, the basification step can be carried out by adding to urine at least one basic pH adjuster, preferentially at least one base, and even more preferentially at least one base chosen from calcium hydroxide, potassium hydroxide, sodium hydroxide and mixtures thereof, as well as the associated oxides and mixtures thereof.

In a particular embodiment of the invention, the base (or bases) used to basify the urine is added to the urine at a concentration of between 0.1 and 10% by weight relative to the total weight of the mixture consisting of urine and the base, preferentially between 0.5 and 2.5%.

When the basification step is carried out by adding at least calcium hydroxide to urine, preferentially the basification step is carried out by adding to urine between 1 and 5% calcium hydroxide by weight relative to the total weight of the mixture of urine and calcium hydroxide, even more preferentially between 2 and 3%.

When the basification step is carried out by adding at least potassium hydroxide to urine, preferentially the basification step is carried out by adding to urine between 1 and 5% potassium hydroxide by weight relative to the total weight of the mixture of urine and potassium hydroxide, even more preferentially between 1.5 and 2%.

When the basification step is carried out by adding at least sodium hydroxide to urine, preferentially the basification step is carried out by adding to urine between 0.5 and 5% sodium hydroxide by weight relative to the total weight of the mixture of urine and sodium hydroxide, even more preferentially between 0.5 and 1%.

The basification step is preferentially carried out at the time the urine is collected, in order to avoid the hydrolysis reaction of the urea in ammonia. In order to minimize the loss of nitrogen, the basification step according to the invention is carried out by adding at least one base into the container in which the urine is received or poured, prior to the reception of the urine, preferentially at the bottom of the container before the urine is poured therein. Once filled, the container is preferentially hermetically sealed for transport in order to limit gas exchanges with the open air, and the container is preferentially made of plastic or metal resistant to corrosion by the base.

In a particular embodiment of the invention, the base(s) can be replaced by a mixture of microorganisms in a basic medium, preferentially a mixture of bacteria, such that the basification is associated with an inoculation of microorganisms, preferentially at least of bacteria. Thus, in this embodiment, the step of basification of the method according to the invention is carried out by adding to urine at least one mixture of bacteria in a basic medium, such that the basification is associated with an inoculation of bacteria. When the basification step is carried out by adding at least bacteria in a basic medium, preferentially the basification step is carried out by adding to urine between 1 and 10% of a mixture of bacteria in a basic medium by weight relative to the total weight of the urine mixture and mixing bacteria in a basic medium, even more preferentially between 2.5 and 5%.

Preferentially, at the end of the basification step:
the ratio NH₄/N-total of the urine is less than or equal to 30%, and/or
the ratio N-ureic/N-total of the urine is greater than or equal to 50%, and/or
the C/N ratio is greater than or equal to 2; it may be greater than or equal to 10.

In one embodiment of the invention, the basification step has a duration of less than 12 days, even more preferentially less than 7 days, and in particular between 12 hours and 7 days.

The urine acidification step is preferentially carried out such that urine has a pH of less than 6, preferentially less than or equal to 5.5 and according to an embodiment less than or equal to 4. The acidification of urine to a pH less than 6 makes it possible to inhibit the growth of the pathogens and prevents the spontaneous reaction of hydrolysis of the urea with ammonia, and therefore the urine retains its nitrogen concentration. Acidification also allows urine to have the pH necessary for fermentation, in particular for lactic fermentation.

The acidification step can be carried out by any means making it possible to obtain a urine with the desired acidic pH. In particular, the acidification step can be carried out by adding to urine at least one acidic pH adjuster, preferentially at least one acid, and even more preferentially at least one acid selected from sulfuric acid, acetic acid, hydrochloric acid, phosphoric acid, nitric acid and lactic acid.

In a particular embodiment of the invention, the acid used to acidify the urine is added to the urine at a concentration of between 0.1 and 10% by weight relative to the total weight of the mixture consisting of urine and the acid, preferentially between 0.5 and 2.5%.

When the acidification step is carried out by adding at least lactic acid to urine, preferentially the acidification step is carried out by adding to urine between 0.5 and 5% lactic acid by weight relative to the total weight of the mixture of urine and acid, even more preferentially between 1 and 2%.

When the acidification step is carried out by adding at least microorganisms in an acidic medium, preferentially bacteria in an acidic medium, the acidification step is preferentially carried out by adding to urine between 1 and 10% of the mixture of microorganisms into an acidic medium by weight relative to the total weight of the mixture of urine and acidifying agent, even more preferentially between 3 and 5%.

The acidification step is preferentially carried out at the time the urine is collected, in order to avoid the hydrolysis reaction of the urea in ammonia. In order to minimize the loss of nitrogen, the acidification step is carried out by adding at least one acid into the container in which the urine is received or poured, prior to the reception of the urine, preferentially at the bottom of the container before the urine is poured therein. Once filled, the container is preferentially hermetically sealed for transport in order to limit gas exchanges with the open air, and the container is preferentially made of plastic or metal resistant to corrosion by the acid.

In a particular embodiment of the invention, the acid(s) can be replaced by a mixture of microorganisms in an acidic medium, preferentially by a mixture of bacteria in an acidic medium, such that the acidification is associated with an inoculation of bacteria. Thus, in this embodiment, the step of acidification of the method according to the invention is carried out by adding to urine at least one mixture of bacteria in an acidic medium, such that the acidification is associated with an inoculation of bacteria.

Preferentially, at the end of the acidification step:
the ratio NH₄/N-total of the urine is less than or equal to 30%, and/or
the ratio N-ureic/N-total of the urine is greater than or equal to 50%, and/or
the C/N ratio is greater than or equal to 2: it may be greater than or equal to 10.

In one embodiment of the invention, the acidification step has a duration of less than 12 days, even more preferentially less than 7 days, and in particular between 12 hours and 7 days.

The method according to the invention may comprise an additional step of storing urine. The urine can be stored at any time of the method, preferentially at any time after the basification or acidification step and before the fermentation step, and according to one suitable embodiment, just after the urine basification or acidification step. According to one variant, the method may comprise several storage steps at different times of the method.

Urine can be stored for an indeterminate period, preferentially for a period of less than or equal to 6 months. Indeed, beyond 6 months the urea is strongly degraded in ammonia, which makes the medium unfavorable to microbial growth.

Storage can be carried out in any suitable container. It may be the container in which the urine was collected, or any other container made of plastic or a metal resistant to base corrosion. Preferentially, the storage is protected from light in order to avoid the effect of UV on the urine composition and at room temperature (approximately 20° C.). The extreme temperatures, i.e. below 0° C. or above 40° C. are unfavorable to storage because it can modify the composition of the urine.

The method according to the invention, before or after optional storage, preferentially just before the transformation step by fermentation, preferentially comprises a filtration step.

This filtration step must make it possible to remove the undesirable particles contained in the urine, such as in particular fur, hair, pollutants in chelated form, residual salts and any other particles that can be present (dead leaves, gravel, etc.).

The filtration step is preferentially carried out at least by filtration on a mesh filter between 0.1 and 80 μm. In particular, the filtration is carried out at 25 μm. This makes it possible to eliminate undesirable particles, depending on the quality of the urine stored.

Filtration can be carried out on an absorbent filter of organic compounds, such as an activated carbon, chabazite, or zeolite filter, or any other filtration system.

The method according to the invention comprises a fermentation step, that is to say transformation of urine under the influence of microorganisms.

The microorganisms used for the fermentation step can be chosen from bacteria and fungi, in particular yeasts and molds.

When the microorganisms used for the fermentation step are fungi, they are preferentially chosen from fungi of the order of Eurotiales, Hypocreales, Saccharomycetales, Glomerales, and mixtures thereof.

Preferentially, the microorganisms used for the fermentation step are bacteria. These bacteria can be lactic acid bacteria (in this case for fermentation, it is referred to specifically as lactic fermentation or lacto-fermentation) or non-lactic bacteria. One or more bacteria can be used for fermentation. The fermentation can therefore be carried out with at least two different bacteria. It may be at least two different lactic acid bacteria in the case where the fermentation is lactic fermentation.

If the fermentation is carried out with one or more non-lactic bacteria, these are preferentially chosen from bacteria belonging to at least one of the following orders: Rhizobiales (in particular the families of Bradyrhizobiaceae, Rhizobiaceae, and Phyllobacteriaceae), Bacillales (in particular the families of Bacillaceae and Paenibacillaceae), Rhodospirillales (in particular the family of Rhodospirillaceae), Actinomycetales (in particular the family of Corynebacteriaceae), Frankiales (in particular the family of Frankiaceae), Burkholderiales (in particular the family of Burkholderiaceae), Flavobacteriales (in particular the family of Flavobactericeae), Pseudomonadales (in particular the family of Pseudomonadaceae), Eubacteriales (in particular the family of Micrococcaceae), Xanthomonadales (in particular the family of Xanthomonadaceae), Hyphomicrobiales, Cytophagales, Chroococcales, Gloeobacterales, des Nostocales, Oscillatoriales, Pleurocapsales, Stigonematales.

If the fermentation is carried out with one or more lactic acid bacteria, the fermentation is carried out with at least one bacterium chosen from bacteria of the order of Lactobacillales, in particular at least one bacterium whose family is chosen from among the Lactobacillaceae, Streptococcaceae, Enterococcaceae, Leuconostocaceae, Bifidobacteriaceae.

Thus, the bacteria used for fermentation are preferentially chosen from bacteria from the family of Bradyrhizobiaceae, Rhizobiaceae, Phyllobactedaceae, Bacillaceae, Paenibacillaceae, Rhodospirillaceae, Corynebacteriaceae, Frankiaceae, Burkholderiaceae, Flavobactericeae, Pseudomonaceae, Micrococcaceae, Xanthomonadaceae, Lactobacillaceae, Streptococcaceae, Enterococcaceae, Leuconostocaceae, Bifidobacteriaceae, and mixtures thereof.

In a preferred embodiment of the invention, the step of transforming urine by fermentation consists of adding into the urine at least one carbon source and at least one inoculum of microorganisms, preferentially an inoculum of bacteria.

The carbon source is preferentially added in a proportion of 1 to 40 g⁻¹ relative to the volume of basified and filtered or acidified and filtered and transformed by fermentation. The carbon source may be diverse. It is preferentially chosen from fructose, glucose, lactose, maltose, saccharose, glucose syrup, malt syrup and polyols such as mannitol or sorbitol and mixtures thereof.

The inoculum of microorganisms, preferentially the bacterial inoculum is preferentially added in a proportion of 0.1 to 10% by volume relative to the volume of the basified and filtered, or acidified and filtered, mixture of urine and of the carbon source.

The microorganism inoculum can be obtained from a mother solution comprising at least one carbon source, a bacterium or a mixture of at least two bacteria, and a basic or acidified urine having a pH suitable for the fermentation of said bacterium or said mixture of bacteria.

For example, the inoculum can be obtained in particular from a mother solution consisting at least of:
the basified urine having a pH greater than or equal to 9, preferentially greater than or equal to 10, and in particular preferentially a pH identical or close to that of the urine that is to be transformed by fermentation,
a carbon source,
and at least one bacterium.

According to another example, the inoculum can be obtained in particular from a mother solution consisting at least of:
urine having a pH less than or equal to 6, preferentially a pH identical or close to that of the urine that it is to be transformed by fermentation,
a carbon source,
and at least one bacterium.

The fermentation step can be carried out in particular at a temperature of between 25 and 35° C. It is preferentially carried out at a temperature corresponding to the optimal growth temperature of the micro-organisms used for the fermentation.

In one embodiment of the invention, the fermentation step is carried out for a duration of at least 12 hours, preferentially for a period of between 3 and 12 days. This duration varies as a function of the microorganisms and the conditions used for fermentation.

Different variants of implementation of the fermentation step of the method according to the invention may for example:
the use of one or more bacteria from the family of Bacillaceae, at a temperature comprised between 20 and 40° C., preferentially 35° C., for 1 to 4 days, preferentially 2 days, on a urine with a pH between 9 and 11, preferentially 9.5, with addition of sugar, preferentially sucrose, between 5 and 20 g·L⁻¹, preferentially 10 g·L⁻¹,
the use of one or more bacteria from the family of Paenibacillaceae, at a temperature comprised between 25 and 40° C., preferentially 30° C., for 1 to 4 days, preferentially 2 days, on a urine with a pH between 9 and 12, preferentially 10, with addition of sugar, preferentially glucose, between 10 and 50 g·L⁻¹, preferentially 40 g·L⁻¹,
the use of one or more bacteria from the family of Pseudomonadaceae, at a temperature comprised between 20 and 40° C., preferentially 35° C., for 1 to 7 days, preferentially 3 days, on a urine with a pH between 9 and 10, preferentially 9.5, with addition of sugar, preferentially glucose, between 10 and 30 g·L⁻¹, preferentially 15 g·L⁻¹,
the use of one or more bacteria from the family of Burkholderiaceae, at a temperature comprised between 20 and 40° C., preferentially 30° C., for 1 to 5 days, preferentially 4 days, on a urine with a pH between 9 and 10, preferentially 10, with addition of sugar, preferentially fructose, between 10 and 20 g·L⁻¹, preferentially 10 g·L⁻¹,
the use of one or more bacteria from the family of Micrococcacea, at a temperature comprised between 25 and 40° C., preferentially 30° C., for 1 to 7 days, preferentially 4 days, on a urine with a pH between 20 and 10, preferentially 10, with addition of sugar, preferentially maltose, between 10 and 40 g·L⁻¹, preferentially 15 g·L⁻¹,
the use of one or more bacteria from the family of Rhizobiaceae, at a temperature comprised between 20 and 35° C., preferentially 30° C., for 2 to 5 days, preferentially 3 days, on a urine with a pH between 6 and 8, preferentially 7, with addition of sugar, preferentially glucose, between 10 and 30 g·L⁻¹, preferentially 20 g·L⁻¹,
the use of one or more bacteria from the family of Lactobacillaceae, at a temperature comprised between 30 and 35° C., preferentially 35° C., for 2 to 5 days, preferentially 3 days, on a urine with a pH between 4.5 and 5.5, preferentially 5.0, with addition of sugar, preferentially lactose, between 30 and 45 g·L⁻¹, preferentially 40 g·L⁻¹,
the use of one or more bacteria from the family of Streptococcaceae, at a temperature comprised between 20 and 30° C., preferentially 25° C., for 5 to 10 days, preferentially 8 days, on a urine with a pH between 5.0 and 6.0, preferentially 5.5, with addition of sugar, preferentially glucose, between 15 and 30 g·L⁻¹, preferentially 20 g·L⁻¹,
the use of one or more bacteria from the family of Enterococcaceae, at a temperature comprised between 25 and 35° C., preferentially 35° C., for 3 to 8 days, preferentially 5 days, on a urine with a pH between 5.0 and 6.0, preferentially 6.0, with addition of sugar, preferentially fructose, between 25 and 35 g·L⁻¹, preferentially 30 g·L⁻¹,
the use of one or more bacteria from the family of Leuconostocaceae, at a temperature comprised between 20 and 30° C., preferentially 25° C., for 8 to 12 days, preferentially 10 days, on a urine with a pH between 3.5 and 5.0, preferentially 4.5, with addition of sugar, preferentially maltose, between 3 and 10 g·L⁻¹, preferentially 5 g·L⁻¹,
the use of one or more bacteria from the family of Bifidobacteriaceae, at a temperature comprised between 30 and 40° C., preferentially 35° C., for 2 to 6 days, preferentially 4 days, on a urine with a pH between 5.0 and 6.0, preferentially 6.0, with addition of sugar, preferentially sucrose, between 5 and 15 g·L⁻¹, preferentially 10 g·L⁻¹,
The method according to the invention may also comprise one or more additional steps.

In particular, the method according to the invention may comprise one or more step(s) that consist(s) of adding to the urine additional constituents, such as in particular nitrogen sources (in ureic form, nitrate/nitrite or ammonium), phosphorus and/or potassium, secondary elements (calcium and/or magnesium) or trace elements (cobalt, copper, iron, manganese and/or zinc). Additional constituents can be added at any time in the implementation of the method. Preferentially, they are added before the fermentation step.

According to one variant of the method, the method may comprise an additional step of adjusting the pH, with the aim of obtaining an optimal pH for the growth of the microorganisms, preferentially bacteria, used during the fermentation step.

The method according to the invention may therefore comprise a step of adding at least one acid or base in the urine that is preferentially basified or acidified. The acid is added so that urine has a lower pH than that obtained after the basification or acidification step. The base is added so that urine has a higher pH than that obtained after the basification or acidification step. The pH is adjusted so that urine has a pH suitable for the growth of the microorganisms used for the fermentation of urine. The adjustment of the pH can also be carried out when the acidified or basified urine is diluted. The pH adjustment to the desired value is carried out by modifying the concentration of the acid or base in urine as a function of the pH of the urine before this addition, of the desired pH, and of the acid or base used.

Preferentially, the acid used for the step of adding an acid in urine to adjust the pH may in particular be chosen from sulfuric acid, acetic acid, hydrochloric acid, phosphoric acid, nitric acid, lactic acid and mixtures thereof.

Preferentially, the base used for the step of adding a base in urine for adjusting the pH may in particular be chosen from calcium hydroxide, potassium hydroxide, sodium hydroxide and mixtures thereof, as well as their respective oxides.

This variant of the method comprising at least one step of adjusting or stabilizing the pH, instead of reaching the desired pH only by basification or acidification of urine after collection, makes it possible to achieve the desired pH in several times (at least two steps): basification of the urine according to the invention then addition of at least one acid or base, or acidification of the urine according to the invention, then adding at least one base or an acid. Thus, whatever the variant, with or without addition of an acid or base, the method according to the invention allows the pH of the urine before transformation by fermentation to have a pH suitable for the growth of the microorganisms used for the fermentation of urine. Thus, a variant of the method according to the invention is characterized in that the pH of the urine before and/or during transformation by fermentation is suitable for the growth of the microorganisms used for the fermentation of urine. The pH of the urine is furthermore to be adapted to the fermentation conditions of the microorganisms used for the fermentation. It may be basic (greater than 7, than 8, than 9, than 10, than 11, than 12 or than 13), or acid (less than 7, than 6, than 5, than 4, than 3 or than 2) or it may be neutral (pH=7).

The step of adding an acid or a base into the basic or acidified urine can be carried out at any time of the method after the basification or acidification step and before the step of transforming urine by fermentation, in particular after the dilution step.

During fermentation, it may also be necessary to stabilize or adjust the pH of the urine, either by adding a base to increase the pH, preferentially chosen from calcium hydroxide, potassium hydroxide, sodium hydroxide and mixtures thereof; or by adding an acid to decrease the pH, preferentially selected from sulfuric acid, acetic acid, hydrochloric acid, phosphoric acid, nitric acid, lactic acid and mixtures thereof. Thus, the method according to the invention may comprise a step of stabilizing the pH, by adding at least one base or at least one acid during the step of transformation of the urine by fermentation.

According to one embodiment, the method according to the invention may comprise the succession of at least the following steps:
basifying the urine (preferentially fresh urine), preferentially so that the urine has a pH greater than 9, preferentially greater than 10, or acidifying the urine, preferentially so that the urine has a pH less than or equal to 6,
optionally storing the basified or acidified urine,
optionally adjusting the pH of the urine to the desired pH by adding a base or an acid,
filtering the urine,
optionally storage, preferentially at a temperature below 10° C., especially between 0 and 5° C., and preferentially for less than 7 days,
diluting the urine in water,
fermentation, optionally comprising a step of stabilizing the pH, by adding at least one base or acid.

The order of the steps of dilution, pH adjustment, and filtration may be reversed (pH adjustment, dilution, filtration: pH adjustment, filtration, dilution; filtration, dilution, pH adjustment; filtration, pH adjustment, dilution; dilution, filtration, pH adjustment; dilution, pH adjustment, filtration).

Finally, the method according to the invention, regardless of the embodiment, may optionally comprise one or more additional steps before the basification or acidification step, between basification or acidification and fermentation or after fermentation, in particular the recovery of co-products such as struvite and biofilms from microorganisms, in particular bacteria.

The urine obtained after the fermentation step is in liquid form. The method according to the invention may also comprise an additional step of concentrating the microorganisms, in particular bacteria (by any suitable means, in particular centrifugation, dehydration and/or freeze-drying) so as to obtain a product in solid form.

Advantageously, the method according to the invention can be implemented on an industrial scale, and makes it possible to obtain a product in a few days. The method according to the invention advantageously makes it possible to reclaim a natural raw material currently considered as waste, which currently requires major, expensive, unsatisfactory treatments.

### Urine Transformed According to the Invention

The invention also relates to a transformed urine, capable of being obtained by implementing the method according to the invention, that is to say transformed at least by dilution and fermentation.

The urine transformed according to the invention preferentially has at least the following characteristics:
a concentration of microorganisms, preferentially of bacteria, of at least 10⁶ UFC·mL⁻¹, preferentially at least 10⁷ UFC·mL⁻¹,
a salt concentration of less than 0.15% by weight,
a nitrogen concentration of less than 0.5% by weight.

The pH of the urine transformed according to the invention may be basic (greater than 7, than 8, than 9, than 10, than 11, than 12 or than 13), or acid (less than 7, than 6, than 5, than 4, than 3 or than 2) or it may be neutral (pH=7).

In one embodiment of the invention, the transformed urine also has at least one of the following features, preferentially at least two, even more preferentially at least three or all of:
a solids content of greater than or equal to 0.5%; this has the advantage of having a particularly suitable quantity of nutrient elements;
a ratio NH₄/N-total of less than or equal to 30%; this makes it possible to have an optimal source of nitrogen usable by the microorganisms, preferentially bacteria;
a ratio N-ureic/N-total greater than or equal to 50%; this feature makes it possible to have a nitrogen source not usable by the microorganisms, preferentially bacteria, but releasing nitrogen for the plants when the transformed urine is used on plants;
a C/N ratio greater than or equal to 2; this feature makes it possible to have optimal growth of the microorganisms, preferentially bacteria.

The urine transformed according to the invention is a complex matrix which in particular comprises nitrogen, phosphorus and potassium. It also contains secondary elements, such as calcium and magnesium, as well as trace elements, such as cobalt, copper, manganese and zinc.

The urine transformed according to the invention can be in liquid form. It is then stored in any suitable container such as bottles, cans, casks or tanks, preferentially made of opaque plastic or metal resistant to corrosion by acidic or basic products.

The transformed urine can also be in solid form, in particular in the form of granules, pellets or powder. The granules and/or pellets can be obtained from mineral substrates, such as zeolite and perlite, as well as from organic substrates, such as bird or bat guano.

Furthermore, the urine transformed according to the invention is preferentially in accordance with the regulations in force concerning safety, in particular on the content of metallic trace elements and of pathogenic organisms.

### Use of the Transformed Urine According to the Invention

The invention also relates to the use of the transformed urine according to the invention, in particular transformed urine obtained by implementing the method according to the invention, as fertilizing substance. Thus, an object of the invention is a fertilizer comprising at least the product obtained by implementing the method according to the invention, that is, a fertilizer comprising at least urine transformed according to the invention.

Indeed, due to its advantageous features, the urine transformed according to the invention can be used as fertilizing substance for any type of plant, including in fields, and regardless of the crop substrate (compost, loam, coconut fiber, etc.) in particular
for field crops, in particular cereals or vines,
in gardening, whether for fruit or vegetables,
in horticulture, for any type of plants, in particular to seedtime.

The use according to the invention is preferentially carried out before seeding or in the first weeks of growth of the plants.

It can also be used in combination with other fertilizing substances, such as mineral and/or organic fertilizers as well as amendments such as compost, in order to improve the absorption of minerals and/or to improve the final quality of the fertilizing substance.

According to a particular embodiment, for certain uses, the urine transformed according to the invention can be used in combination with excipients or additives such as, in particular, one or more adhesives known to the person skilled in the art for fixing the microorganisms on the plant parts of interest, in particular on seeds.

In one embodiment of the invention, the transformed urine is used to stimulate the growth of plants, in particular by stimulating growth in the vegetative phase by means of plant growth promoting factors produced by the microorganisms present in the transformed urine, in particular by bacteria.

For the use thereof:
when the urine transformed is liquid, it is preferentially diluted in water. For field inputs, the dose of use of liquid product is recommended between 5 to 50 L/ha diluted in 50 to 500 L of water. For the other inputs, as for potted plants, the liquid product is used in a proportion of 5 to 50 mL per liter of water,
when the transformed urine is solid, it is preferentially applied directly to the soil. For field inputs, the dose of solid product is recommended between 0.5 to 5 kg/ha. For the other inputs, as for potted plants, the solid product is used in a proportion of 0.5 to 5 g per plant.

Thus, the product according to the invention can be used in a small amount to obtain a large effect on the growth of the plants.

Advantageously, the fertilizing substance according to the invention is derived from a natural product. Its method does not involve any solvent. It is in no way dangerous to humans or the environment.

### Use of Co-Products of the Urine Transformation Method

The invention also relates to the use of co-products obtained during the implementation of a method according to the invention.

Indeed, co-products are generated during the storage step before basification and during the fermentation step, and in particular
before acidification or basification: minerals, in particular minerals chosen from nitrogen, potassium and phosphorus (struvite),
during the fermentation step: the biofilm of microorganisms, preferentially the bacterial surface biofilm. The biofilm of microorganisms is produced by the microorganisms during the fermentation. Bacterial biofilm is produced by bacteria during fermentation. It is composed of exopolysaccharides in particular. This surface film can be recovered by means of a scraper provided with a mesh filter of between 1 and 10 μm. The biofilm can subsequently undergo various treatments, such as washing, dissolving, pressing and/or open-air drying in order to obtain a material in liquid or solid form.

These co-products have characteristics which advantageously allow their use as fertilizing substance, plant protection product, biocontrol product, or any other agricultural use.

### EXAMPLES

The invention will now be illustrated using examples.

### Example 1: A Method for Transforming a Urine According to the Invention with Dilution and Frankia sp.

An example method according to the invention comprises the following steps:
adding fresh urine at initial pH (6.5 to 7) into a plastic container;
diluting the urine (1 volume of urine for 9 volumes of demineralized water),
adding to urine 30 g·L⁻¹ of glucose, and adding 1% by volume of an inoculum of Frankia sp. (1 L for every 100 L urine), at 32° C. for 5 days under continuous stirring (about 150 revolutions per minute); -recovering the transformed urine.
the final concentration of bacteria is of the order of 10⁷ UFC·mL⁻¹.

The inoculum used was previously obtained as follows:
diluting the urine (1 volume of urine for 9 volumes of demineralized water),
filtering with a 0.2 μm mesh filter;
adding 30 g·L¹ glucose;
adding 100 mg of the strain of Frankia sp preserved in concentrated liquid form;
fermenting (bacterial growth) at 32° C. under continuous agitation (about 150 revolutions per minute) for 3 days;
the final concentration of bacteria obtained in the inoculum is of the order of 10⁶ UFC·mL⁻¹.

The transformed urine obtained has the following characteristics:
a pH of about 7.
a concentration of bacteria greater than 10⁷ UFC·mL⁻¹,
a salt concentration of less than 0.05% by weight,
a nitrogen concentration of less than 0.1% by weight.
a ratio of NH₄/N-total equal to 10%,
a ratio of N-ureic/N-total equal to 60%,
a C/N ratio equal to 30.

### Example 2: A Method for Transforming a Urine According to the Invention with NaOH Basification, Acidified Urine Dilution, and Kocuria sp.

An example method according to the invention comprises the following steps:
placing 0.6% by weight of 30.5% sodium hydroxide, in the bottom of the plastic container (for 100 L of total volume urine+sodium hydroxide, add 0.6 L of 30.5% sodium hydroxide);
adding fresh urine at initial pH (6.5 to 7) in the plastic container (for 0.6 L of sodium hydroxide already present in the container, complete to 100 L with urine);
the mixture has an upper pH equal to 9.0, it can be stored under these conditions up to 6 months in a hermetic plastic container, at room temperature and away from light;
diluting the basified urine (1 volume of urine for 9 volumes of demineralized water),
filtering the basified urine with a filter made of nylon or a 25 μm mesh plastic material;
adding to the diluted urine 20 g·L⁻¹ of fructose, and adding 1% by volume of an inoculum of Kocuria sp. (1 L for every 100 L urine), at 30° C. for 5 days under continuous stirring (about 150 revolutions per minute);
recovering the basic, diluted and transformed urine after recovery of the coproducts and in particular of the biofilm formed.

The inoculum used was previously obtained as follows:
basifying 10 L urine to reach a pH greater than or equal to 9, by adding 0.6% by weight of sodium hydroxide at 30.5% (60 g of sodium hydroxide per 10 L);
diluting the urine (1 volume of urine for 9 volumes of demineralized water),
filtering the basified urine with a 0.2 μm mesh filter;
adding 20 g·L⁻¹ fructose;
adding 100 mg of the strain of Kocuria sp. preserved in concentrated liquid form;
fermenting at 30° C. under continuous stirring (about 150 revolutions per minute) for 3 days;
the final concentration of bacteria obtained in the inoculum is of the order of 10⁶ UFC·mL⁻¹.

The transformed urine obtained has the following characteristics:
a pH equal to 8,
a concentration of bacteria greater than 10⁷ UFC·mL⁻¹,
a salt concentration of less than 0.1% by weight,
a nitrogen concentration of less than 0.1% by weight.
a ratio of NH₄/N-total equal to 10%,
a ratio of N-ureic/N-total equal to 60%,
a C/N ratio equal to 20.

### Example 3: A Method for Transforming a Urine According to the Invention with NaOH Basification, Dilution, pH Adjustment, and Rhizobium sp.

An example method according to the invention comprises the following steps:
placing 0.6% by weight of 30.5% sodium hydroxide, in the bottom of the plastic container (for 100 L of total volume urine+sodium hydroxide, add 0.6 L of 30.5% sodium hydroxide);
adding fresh urine at initial pH (6.5 to 7) in the plastic container (for 0.6 L of sodium hydroxide already present in the container, complete to 100 L with urine);
the mixture has an upper pH equal to 9.0, it can be stored under these conditions up to 6 months in a hermetic plastic container, at room temperature and away from light;
diluting the basified urine (1 volume of urine for 9 volumes of demineralized water),
adjusting/stabilizing the pH with addition of nitric acid and sodium hydroxide to have a pH=7;
filtering the urine at pH 7 with a filter made of nylon or a 25 μm mesh plastic material;
adding to the diluted urine 15 g·L⁻¹ of sucrose, and adding 1% by volume of an inoculum of Rhizobium sp. (1 L for every 100 L urine), at 30° C. for 5 days under continuous stirring (about 150 revolutions per minute);
recovering the basified, transformed urine after recovery of the coproducts and in particular of the biofilm formed.

The inoculum used was previously obtained as follows:
basifying 10 L urine to reach a pH greater than or equal to 9, by adding 0.6% by weight of sodium hydroxide at 30.5% (60 g of sodium hydroxide per 10 L);
diluting the urine (1 volume of urine for 9 volumes of demineralized water),
adjusting/stabilizing the pH with addition of nitric acid and sodium hydroxide to have a pH=7;
filtering the urine at pH 7 with a 0.2 μm mesh filter;
adding 15 g·L⁻¹ sucrose;
adding 100 mg of the strain of Rhizobium sp. preserved in concentrated liquid form;
fermenting at 30° C. under continuous agitation (about 150 revolutions per minute) for 3 days;
the final concentration of bacteria obtained in the inoculum is of the order of 10⁶ UFC·mL⁻¹.

The transformed urine obtained has the following characteristics:
a neutral pH at about 7,
a concentration of bacteria greater than 10⁸ UFC·mL⁻¹,
a salt concentration of less than 0.1% by weight,
a nitrogen concentration of less than 0.1% by weight.
a ratio of NH₄/N-total equal to 10%,
a ratio of N-ureic/N-total equal to 60%,
a C/N ratio equal to 15.

### Example 4: A Method for Transforming a Urine According to the Invention with Lactic Acid, Dilution and Lactobacillus sp.

An example method according to the invention comprises the following steps:
placing 1% by weight of lactic acid in the bottom of the plastic container (for every 100 L of urine, add 1 kg of lactic acid, i.e. approximately 0.83 L)
adding the urine at initial pH (6.5 to 7) in the plastic container (for 0.83 L of lactic acid, completing to 100 L);
the mixture has a pH equal to 4.0, it may be stored under these conditions up to 6 months in a hermetic plastic container, at room temperature and away from light;
diluting the acidified urine (1 volume of urine for 1 volumes of demineralized water),
filtering the acidified urine with a filter made of nylon or a 25 μm mesh plastic material;
adding to the acidified and filtered urine 1% by volume of an inoculum of Lactobacillus sp. (1 L per 100 L of acidified urine) and 25 g·L⁻¹ of sucrose (white sugar), at 34° C. for 10 days under continuous stirring (between 50 and 100 revolutions per minute);
recovering the acidified, transformed urine after recovery of the coproducts and in particular of the biofilm formed.

The inoculum used was previously obtained as follows:
acidifying 10 L of urine to reach a pH less than or equal to 4, by adding lactic acid at 1% by weight (100 g of acid per 10 L),
diluting the acidified urine (1 volume of urine for 1 volumes of demineralized water),
filtering the acidified urine with a 25 μm mesh filter;
adding 100 mg of the strain of Lactobacillus sp. preserved in concentrated liquid form;
adding 25 g·L⁻¹ of sucrose (white sugar);
fermenting at 30° C. for 5 days;
the final concentration of bacteria obtained is of the order of 10⁶ UFC·mL⁻¹.

The acidified and transformed urine obtained has the following characteristics:
a pH of less than or equal to 5,
a concentration of Lactobacillus sp. of 10⁶ to 10⁷ UFC·mL⁻¹,
a salt concentration of less than 0.15% by weight,
a nitrogen concentration of less than 0.5% by weight.
a ratio of NH₄/N-total equal to 10%,
a ratio of N-ureic/N-total equal to 60%,
a C/N ratio equal to 3.

### Test Results

### Evaluation of Dilution Factors on Urine

The purpose of this test is to evaluate the effect of dilution on the pH of fresh urine.

The test was carried out on 1 L of fresh urine stored for less than 2 hours, or urine stored for 5 days, or urine acidified with lactic acid (1% by weight), or urine basified with sodium hydroxide (0.6% by weight).

A range of dilution factors with demineralized water was tested, between 1/2 and 1/20

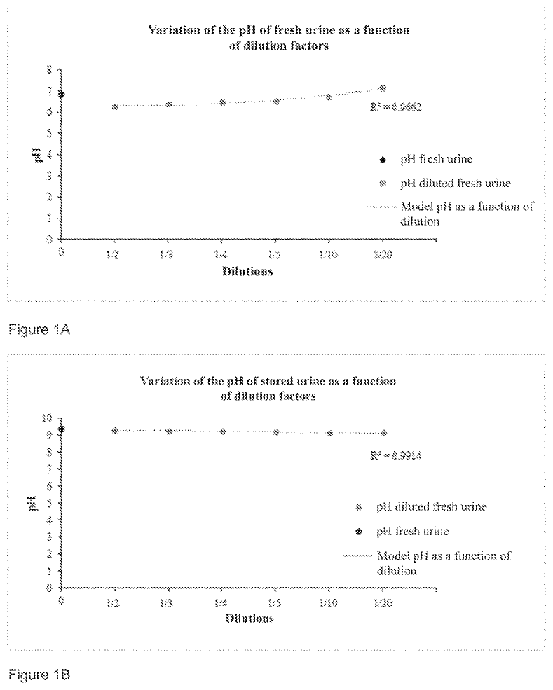

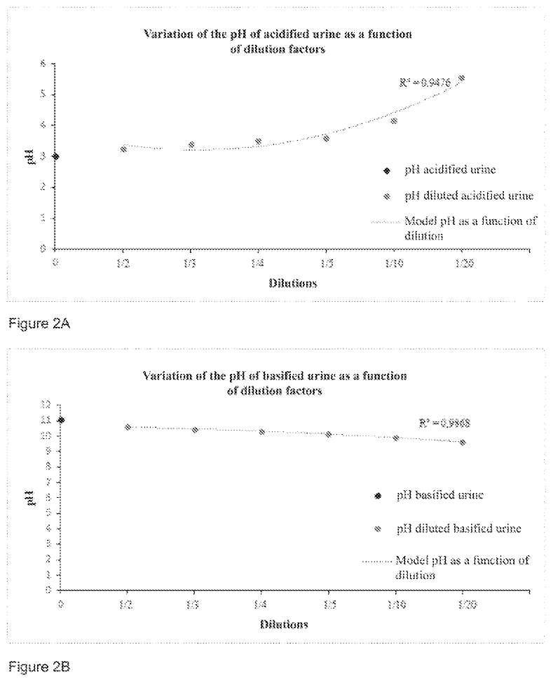

The results are shown in FIGS. 1a, 1b, 2a and 2b and in the table below.

TABLE 1

| | pH of the | pH of the | pH of the | pH of the |
|---|---|---|---|---|
| Dilution | fresh urine | urine stored | acidified urine | basified urine |
| factor | (FIG. 1a) | (FIG. 1b) | (FIG. 2a) | (FIG. 2b) |
| 0 | 6.85 | 9.38 | 3.03 | 11.04 |
| 1/2 | 6.27 | 9.29 | 3.24 | 10.63 |
| 1/3 | 6.38 | 9.26 | 3.4 | 10.41 |
| 1/4 | 6.47 | 9.23 | 3.51 | 10.31 |
| 1/5 | 6.51 | 9.2 | 3.6 | 10.17 |
| 1/10 | 6.74 | 9.15 | 4.17 | 9.92 |
| 1/20 | 7.14 | 9.13 | 5.57 | 9.6 |

It is noted that dilution makes it possible to achieve a neutral pH for fresh urine. The effects of dilution on the pH of the stored, acidified and basified urine only cause an average difference of 1 to 2 points of pH.

### Example 4: Measurement of the Growth Capacity of Ensifer meliloti in Diluted Urine

### Objectives

Assess the capacity of the bacterial species Ensifer meliloti (known to be in symbiosis with leguminous plants, in particular alfalfa, by forming nodules on the roots and thus facilitating nitrogen fixing by the plant) to develop on urine.
Characterizing an optimal culture medium based on human urine allowing the best growth of E. meliloti.

### Principle of the Test

The principle of this test is based on a comparison of the bacterial growth of several cultures of E. meliloti according to various modalities (pure urine, urine diluted to 1/2 and urine diluted to 1/5) in order to determine the ideal dilution level for the growth of the bacterium.

### Material and Methods

### Strain Used

The Ensifer meliloti strain is used.

### Determination of the Culture Conditions

The choice of the E. meliloti growth conditions was carried out based on a comparison of the concentrations of nitrogen (N), of phosphorus (P) and of potassium (K) present in the reference culture medium (Wright medium) and those present in the urine.

Firstly, the nitrogen concentration of the chosen reference medium is zero, unlike the urine-based medium which contains 5 g/L of this element. With regard to phosphorus, the concentration present in the urine is 0.5 g/L, which is greater than that of the reference medium which is 0.09 g/L. Likewise, the potassium concentration is higher in urine than in the reference medium, by respectively 1.5 g/L and 0.22 g/L. It can therefore be concluded that urine is richer in nitrogen, phosphorus and potassium than the reference culture medium. Based on these facts, it may be assumed that the optimal dilution level for the growth of B. meliloti is 1/5. However, tests were carried out on three different culture media: pure urine, urine diluted to 1/2 and urine diluted to 1/5 in order to verify the hypothesis.

On carbon substrates, sucrose is the sugar essentially present in most culture media used for the growth of E. meliloti (Shamala, 2006). With the aim being optimal growth of the bacterium, all the cultures were carried out using only sucrose as carbonaceous substrate and at a concentration of 10 g/L. According to the same reflection, the pH was set at 7 and the temperature at 34° C. for fermentation under aerobic conditions.

### Growth on Various Culture Media

To sterilize the urine used in this test, prior filtration was carried out at 0.2 μm and the pH was measured and adjusted to 7 by adding sodium hydroxide (30% NaOH).

Firstly, a preculture was carried out from colonies derived from the agar tube provided by the INRAE. The colonies were inoculated in a 250 mL Erlenmeyer flask containing a volume of 100 mL of the Rhizobium culture medium (10.0 g mannitol, 0.5 potassium hydrogen phosphate, 0.2 g magnesium sulfate, 0.1 g NaCl, 1.0 g yeast extract). This preculture made it possible to revitalize the cells and to obtain a liquid culture that is very concentrated in bacteria. After 2 days of incubation at 34° C., the optical density of the preculture was measured and the inoculation rate is calculated and adjusted in order to guarantee an optical density of 0.05 in all the cultures. Three replications were carried out for each form (not diluted, diluted to 1/2 and diluted to 1/5).

These replications were carried out in culture volumes of 100 mL contained in 250 mL Erlenmeyer flasks and incubated at 34° C. with stirring (350 rpm) for a period of 6 days. E. meliloti being an aerobic bacterium, the Erlenmeyer flasks containing the cultures were plugged with cotton in order to allow gas exchanges.

### Counting the Bacteria

The counting of cultivable or CFU (colony forming unit) bacteria was carried out by counting colonies. For this, decimal dilutions of the culture to be analyzed are carried out and placed (in drops of 10 μL) on a “Rhizobium” agar medium box. The dishes are incubated at room temperature for a few days until colonies are obtained that are sufficiently visible to count them.

### Statistical Analyses

In order to know whether the differences obtained between the cultures are significant, a statistical test was carried out. The continuous and independent quantitative data do not follow the normal law. Given that 3 groups have been studied, it is the Kruskal-Wallis test that was chosen to study the significance of the difference between the results. This difference is considered to be significant when p-value≤0.05

### Results Obtained

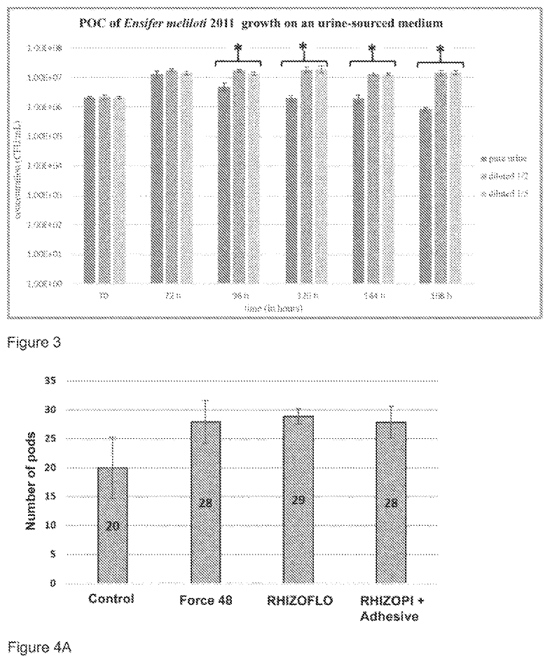

The results of the growth of E. meliloti on pure urine, urine diluted to 1/2 and urine diluted to 1/5 are presented in FIG. 3. For each form, the values correspond to the average of three different counts carried out on each replicate and the error bars correspond to the standard deviations of these averages.

The growth results show that after 96 hours of culture, a significant difference in the bacterial concentration between pure urine and urine diluted to 1/5 is observed. The bacterial concentration remains stable up to 168 hours in urine diluted to 1/5.

Given that the inoculation rate was adjusted to an initial concentration of 2×10⁶ CFU/mL, these results indicate for the first time that the species E. meliloti is able to grow in urine.

### Conclusion

In conclusion, this test made it possible to:
demonstrate, for the first time, the capacity of the Ensifer meliloti bacterial strain to develop in a urine-based culture medium.
define, among the forms tested, the urine medium diluted to 1/5 for its benefit in the culture of the bacterial strain of the Ensifer meliloti species

### Example 5: Measuring the Efficacy of the Invention Used by Inoculation of Seed on Soybean

The objective of this test is to evaluate the efficacy of a urine transformed according to the invention comprising symbiotic bacteria that fix nitrogen on soybean plants.

### Principle of the Test

The principle of this test is based on a comparison of the growth of soy plants grown in a field according to various means of inoculation with commercial products containing the bacterium Bradyrhizobium japonicum (FORCE 48, Rhizo-flo) and the product according to the invention (denoted “RHIZOPI” in the Figures).

The product according to the invention is used at different doses (400 mL/ha or 5 L/ha), with or without adhesive in order to determine the most effective mode of application.

### Material and Methods

### Preparation of the Product According to the Invention (“RHIZOPI”)

A strain of Bradyrhizobium japonicum is used.

The culture medium used to grow this strain is urine previously diluted to 1/2 with distilled water stabilized by acidification to pH 3.5 (using lactic acid) filtered at 0.2 μm and then adjusted to pH 7 by adding 30% NaOH. Mannitol is then added as a carbonaceous substrate at a concentration of 30 g/L. The culture was carried out in a 100 mL Schott flask, the urine medium was inoculated at 1% with a culture of B. japonicum on YMB in stationary phase. The cultures were then stirred (150 rpm) and incubated at 34° C. for a period of 14 days.

An adhesive known to the person skilled in the art for soy seeds was added to the urine. An adhesive is also present in the commercial products tested in this test (RHIZOFLO and FORCE 48).

### Description of the Test

The test is carried out in the crop field, in the commune of Castétis, France (64300). The chosen patch has a clay sandy loamy soil having an acidic pH (pH=6.2) and has never been planted with soy in order to avoid any presence in the soil of B. japonicum resulting from previous cultures. The variety of soy used is the variety KONTROLL. The test is conducted in microplots in Fisher randomized blocks with 4 repetitions.

TABLE 2

| Form | Description |
|---|---|
| 1 | Uninoculated control |
| 2 | Inoculation with FORCE 48 (containing an adhesive as the |
| | invention) |
| 3 | Inoculation with RHIZOFLO (containing an adhesive as the |
| | invention) |
| 4 | RHIZOPI inoculation (10⁹) + adhesive |

### Settings Measured

The measured parameters aim to estimate the impact of the type of inoculation on the nodules of the plants, and therefore on their growth, vigor, nutrition, and productivity. The measurements made are as follows:
Lift density
Vigor at the 3-4 leaf stage (BBCH 13) and first pods (BBCH 65)
Number of nodosities per plant in the BBCH 13 and 65 stages
Diseases
Flowering date
Height of first pod
Number of pods per plant
Protein content

### Statistical Analyses

The statistical analyses were carried out using R and R Studio software. In order to know whether the differences obtained between the forms are significant (p-value≤0.05), measurements of one-way ANOVA analysis of variance (Form) were carried out for each parameter measured during the test. Prior to the ANOVA, the various datasets obtained were used to evaluate their parametric or non-parametric nature. For the parametric data, an ANOVA was carried out, potentially followed by a multiple comparison post-hoc test in order to visualize the groups statistically different from each other. For this, the Tuckey HSD (Honestly Significant Differences) test is used. For non-parametric data, the significant differences between terms were evaluated using a Kruskal-Wallis test, potentially followed by a post-hoc Dunn's test. All risk thresholds were defined at α=0.05.

### Results Obtained

### Yield Components:

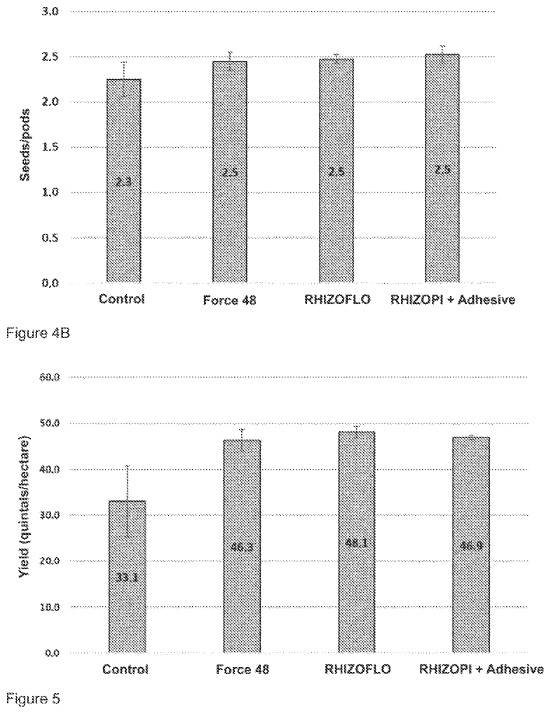

The results concerning the yield components are presented in FIGS. 4a and 4b. Regardless of the parameter considered, it is observed that the forms inoculated with the commercial products and those inoculated with the invention belong to the same significant group and obtain significantly higher values than the non-inoculated control.

### Yield:

The yield results presented in FIG. 5 show that the inoculated forms according to the invention belong to the same significant group as the reference forms (FORCE 48 and RHIZOFLO).

### Moisture and TKW:

All of the forms belong to the same significant group as regards the moisture of the seeds and the TKW. The inoculation therefore does not seem to have any effect on these parameters.

### Conclusion

To conclude, this analysis made it possible to show:

The positive influence of the inoculation according to the invention on the number of nodosities, the defoliation date, rain splash, the yield components, and the yield.
The urine transformed according to the invention makes it possible to obtain results similar to those of the FORCE 48 form.

1. A method for treating human or animal urine characterized in that it comprises at least:
a step of diluting the urine in water, and
a step of fermentation.

2. The method according to claim 1, characterized in that it comprises the following steps:
basifying or acidifying the urine,
diluting the urine in water,
filtering the urine,
transforming urine by fermentation.

3. The method according to claim 1, characterized in that it comprises a step of basifying the urine such that the urine has a pH greater than or equal to 9.

4. The method according to claim 3 characterized in that the step of basifying the urine is carried out such that the urine has a pH greater than or equal to 10.

5. The method according to claim 2, characterized in that the step of basification is carried out by adding to the urine at least one base chosen from calcium hydroxide, potassium hydroxide, sodium hydroxide and mixtures thereof.

6. The method according to claim 2, characterized in that the base is added at a concentration of between 0.1 and 10% by weight relative to the total weight of the urine and base mixture.

7. The method according to claim 1, characterized in that it comprises a step of acidifying the urine at a pH of less than or equal to 6.

8. The method according to claim 7, characterized in that the step of acidification is carried out by adding to the urine at least one acid selected from sulfuric acid, acetic acid, hydrochloric acid, phosphoric acid, nitric acid, lactic acid and mixtures thereof.

9. The method according to claim 7, characterized in that the acid is added at a concentration of between 0.1 and 10% by weight relative to the total weight of the urine and acid mixture.

10. The method according to claim 1, characterized in that it is implemented on urine collected less than 10 hours earlier.

11. The method according to claim 2, characterized in that the step of basification or acidification is carried out by adding at least one base or at least one acid into the container in which the urine is received, prior to the reception of the urine.

12. The method according to claim 1, characterized in that the step of basification or acidification is carried out by adding to the urine at least one mixture of microorganisms in a basic medium or at least one mixture of microorganisms in an acidic medium, such that the basification or acidification is associated with an inoculation of microorganisms.

13. The method according to claim 1, characterized in that it comprises a step of adjusting the pH by adding at least one base and/or at least one acid.

14. The method according to claim 1, characterized in that the pH of the urine before and/or during transformation by fermentation is adjusted to be adapted to the growth of the microorganisms used for the fermentation of urine.

15. The method according to claim 2, characterized in that the filtration is carried out on a mesh filter between 0.1 and 80 μm.

16. The method according to claim 2, characterized in that the filtration is carried out on an absorbent filter of organic compounds.

17. The method according to claim 1, characterized in that the fermentation step consists of adding in the urine at least one carbon source and at least one inoculum of microorganisms.

18. The method according to claim 17, characterized in that the bacterial inoculum is added at 0.1 to 10% by volume relative to the volume of the mixture of urine and the carbon source.

19. The method according to claim 1, characterized in that the fermentation is carried out with at least one bacterium selected from the bacteria of the family of Bradyrhizobiaceae, Rhizobiaceae, Phyllobacteriaceae, Bacillaceae, Paenibacillaceae, Rhodospirillaceae, Corynebacteriaceae, Frankiaceae, Burkholderiaceae, Flavobactericeae, Pseudomonaceae, Micrococcaceae, Xanthomonadaceae, Lactobacillaceae, Streptococcaceae, Enterococcaceae, Leuconostocaceae, Bifidobacteriaceae, and mixtures thereof.

20. The method according to claim 1, characterized in that the step of dilution of urine in water is carried out with a factor of between 1/2 and 1/20.

21. A transformed urine, capable of being obtained by implementing the method according to claim 1, characterized in that it has the following characteristics:
a concentration of microorganisms, preferentially of bacteria, of at least 10⁶ UFC·mL⁻¹,
a salt concentration of less than 0.15% by weight of salt relative to the volume of transformed urine,
a nitrogen concentration of less than 0.5% by weight of nitrogen relative to the volume of transformed urine.

22. The transformed urine according to claim 21,
characterized in that it also has at least one of the following features:
a solids content of greater than or equal to 1%,
a ratio of NH₄/N-total less than or equal to 30%,
a ratio of N-ureic/N-total greater than or equal to 50%,
a C/N ratio greater than or equal to 2.

23. The transformed urine according to claim 21, characterized in that it is in solid, liquid or freeze-dried form.

24. A fertilizer comprising at least one transformed urine according to claim 21.

25. A use of a transformed urine according to claim 21 as fertilizing substance.

26. The use of a transformed urine according to claim 21, for the stimulation of plant growth.

27. The use according to claim 25, characterized in that the transformed urine is diluted in water at 1 to 50 mL of liquid transformed urine per liter of water.

28. The use of co-products obtained in the fermentation step during the implementation of a method according to claim 1 as fertilizing substance, plant protection product, biocontrol product.
